(19) United States
(12) Patent Application Publication
(10) Pub. No.: US 2019/0168248 A1
(43) Pub. Date: Jun. 6, 2019

(54) RESERVOIR FILTER FOR HAND-HELD SPRAY GUNS

(71) Applicant: 3M INNOVATIVE PROPERTIES COMPANY, St. Paul, MN (US)

(72) Inventors: John W. Henderson, St. Paul, MN (US); Stephen C.P. Joseph, Woodbury, MN (US); Matthew V. Croyle, Woodbury, MN (US)

(21) Appl. No.: 16/323,469

(22) PCT Filed: Jul. 31, 2017
(86) PCT No.: PCT/US2017/044630

§ 371 Date: Feb. 5, 2019

Related U.S. Application Data
(60) Provisional application No. 62/371,371, filed on Aug. 5, 2016.

(51) Int. Cl. B05B 15/40; B05B 7/24

(52) U.S. Cl. CPC B05B 15/40; B05B 7/2478; B05B 7/2408

(57) ABSTRACT

A spray gun reservoir including a cup, a lid, and a filter. The cup defines an internal containment volume. The lid defines an outlet. The filter is disposed between the containment volume and the outlet such that liquid flow from the containment volume to the outlet interfaces with the filter. The filter includes a knitted fabric filter media. The knitted fabric filter media can include filaments knitted in a pattern defining a plurality of pores, and is formed, at least in part, by warp knitting or weft knitting. At least some of the pore can be non-square in shape, including a triangular shape. The pores can be distributed across the knitted fabric filter media in a controlled, non-random manner. The knitted fabric filter media can include first and second layers of knitted fabric arranged to define a depth filter.

### BACKGROUND

The present disclosure relates to liquid spraying apparatuses, such as spray guns. More particularly, it relates to the filters useful with spray guns, and in particular with reservoirs containing the liquid to be sprayed.

Spray guns are widely used to apply a liquid to a substrate in a variety of industries. In the known spray guns, the liquid is contained in a reservoir attached to the gun from where it is fed to a spray nozzle. On emerging from the spray nozzle, the liquid is atomized and forms a spray with compressed air supplied to the nozzle. The liquid may be gravity fed or suction fed or, more recently, pressure fed by an air bleed line to the reservoir from the compressed air line to the spray gun, or from the spray gun itself.

### SUMMARY

A common application of spray guns is in vehicle body repair shops when re-spraying a vehicle that has been repaired following an accident. A typical paint finish may require application of a primer, sealer, base coat, top coat and a clear coat or clear lacquer. The presence of contaminants such as solid particles in the liquid to be sprayed can spoil the paint finish and extensive re-working (e.g., sanding, compounding, and polishing; defect removal; de-nibbing; etc.) is required to achieve an acceptable paint finish. In some instances, the solid particles may cause blockage of the spray gun itself requiring stripping down and cleaning of the spray gun to remove the blockage. In addition, the blockage may have an adverse effect on the spray and render the resulting paint finish unacceptable so that extensive re-working is again required to produce an acceptable paint finish. Re-working of the paint finish and, where required, unblocking of the spray gun, adds to costs both in terms of materials and time.

It is already known to provide a filter in the reservoir to remove contaminants as the liquid is withdrawn from the reservoir during operation of the spray gun. For example, one popular reservoir design is the PPS™ Paint Preparation System available from 3M Company of St. Paul, Minn., and includes a reusable outer container or cup, an open-topped liner, and a lid. A filter is carried by the lid. The liner fits into the outer container, and paint (or other liquid) that is to be sprayed is contained within the liner. The lid is assembled with the liner and provides a spout or conduit through which the contained paint is conveyed. In this regard, the contained liquid must pass through or interface with the filter when flowing to the spout. A number of other reservoir designs also incorporate a filter.

Regardless of an exact design of the spray gun reservoir, the in-lid filter is conventionally a woven mesh material or media, normally a single layer or sheet of woven nylon mesh. The woven mesh filter is formatted to provide a uniform pattern of essentially identically sized and shaped pores. While well-accepted as an in-lid, spray gun reservoir filter, it can be difficult for some manufacturers to reliably produce silicone-free woven nylon mesh filters on a mass production basis due to the common industry use of silicone lubricants; the presence of silicone in the filter can negatively affect some paint finishing products.

As a point of reference, paint manufacturers specify at least a minimum pore size or pore size range for filters to be used with a particular paint product (e.g., so as to ensure that necessary constituents of the paint product are not removed by the filter). A specified minimum pore size for many paint finishing products may be in the range of about 80-500 micron, with either 125 micron or 200 micron meeting the criteria of most paint suppliers. Reservoir manufacturers, in turn, endeavor to provide end users with filter options (e.g., in-lid filter) commensurate with the paint manufacturer's specifications. Thus, for example, users of the PPS™ Paint Preparation System can select a lid carrying a 125 micron filter or a lid carrying a 200 micron filter. In addition to product labeling, reservoir manufacturers may incorporate different color schemes into the filter-carrying lid for a user to more quickly identify the pore size of the particular in-lid filter.

The inventors of the present disclosure recognized that a need exists for spray gun reservoir filters that overcome one or more of the above-mentioned problems.

Some aspects of the present disclosure are directed toward a spray gun reservoir including a cup, a lid, and a filter. The cup defines an internal containment volume. The lid defines an outlet. The filter is disposed between the containment volume and the outlet such that liquid flow from the containment volume to the outlet interfaces with the filter. The filter includes a knitted fabric filter media. In some embodiments, the knitted fabric filter media includes filaments knitted in a pattern defining a plurality of pores, and is formed, at least in part, by warp knitting, alternatively by weft knitting. In related embodiments, at least some of the pores are non-square in shape, including a triangular shape. In other embodiments, the pores are distributed across the knitted fabric filter media in a controlled, non-random manner. In yet other embodiments, the knitted fabric filter media includes first and second layers of knitted fabric arranged to define a depth filter.

As used herein, the term “liquid” refers to all forms of flowable material that can be applied to a surface using a spray gun (whether or not they are intended to color the surface) including (without limitation) paints, primers, base coats, lacquers, varnishes and similar paint-like materials as well as other materials, such as adhesives, sealer, fillers, putties, powder coatings, blasting powders, abrasive slurries, mold release agents and foundry dressings which may be applied in atomized or non-atomized form depending on the properties and/or the intended application of the material and the term “liquid” is to be construed accordingly.

### BRIEF DESCRIPTION OF THE DRAWINGS

FIG. 1 is a perspective view of a spray gun assembly including a spray gun and a reservoir;

FIG. 2 is a perspective view of the reservoir shown in FIG. 1 separate from the spray gun;

FIG. 3 is a longitudinal cross-sectional view of the reservoir of FIG. 2 and illustrating a filter in accordance with principles of the present disclosure;

FIG. 4 is a simplified, enlarged plan view of a portion of a knitted fabric material useful with the filters of the present disclosure;

FIG. 5 is a simplified, enlarged plan view of a portion of another knitted fabric material useful with the filters of the present disclosure;

FIG. 6 is a simplified, enlarged plan view of a portion of another knitted fabric material useful with the filters of the present disclosure;

FIG. 7 illustrates a simplified comparison of a woven fabric and a knitted fabric;

FIG. 8 is a simplified perspective view of a knitted fabric filter media in accordance with principles of the present disclosure;

FIG. 9 is a micrograph of a portion of another knitted fabric filter in accordance with principles of the present disclosure;

FIG. 10 schematically illustrates a relationship of a particle relative to a pore provided with some knitted fabric filters of the present disclosure;

FIG. 11 is a photograph of another knitted fabric filter material useful with the filters of the present disclosure;

FIGS. 12A-12E are micrographs of knitted fabric materials useful with the filters of the present disclosure;

FIG. 13 is a micrograph of a portion of another knitted fabric filter in accordance with principles of the present disclosure;

FIG. 14 schematically illustrates arrangement of components of a flow rate test described in the Examples section; and

FIG. 15 is a graph of the results of the flow rate testing described in the Examples section.

### DETAILED DESCRIPTION

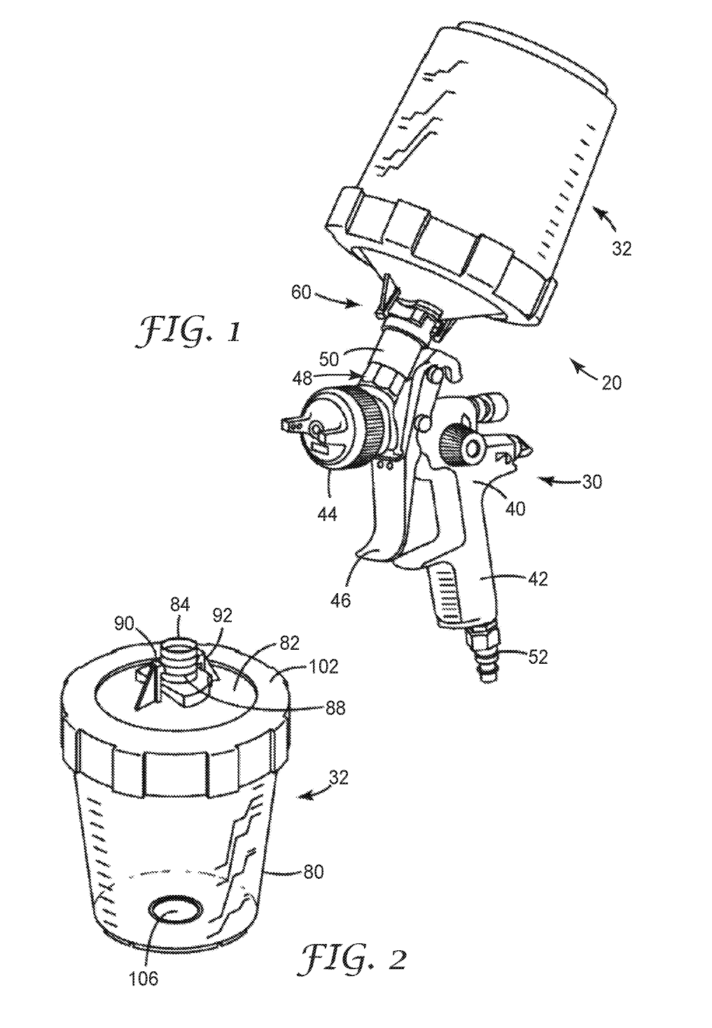

Aspects of the present disclosure are directed toward filters useful with spray gun paint systems, for example filters provided with a reservoir component of a spray gun paint system. By way of background, FIG. 1 depicts a spray gun paint system 20 including a spray gun 30 of a gravity-feed type and a reservoir 32. The gun 30 includes a body 40, a handle 42, and a spray nozzle 44 at a front end of the body 40. The gun 30 is manually operated by a trigger 46 that is pivotally mounted on the sides of the body 40. An inlet port 48 (referenced generally) is formed in or carried by the body 40, and is configured to establish a fluid connection between an interior spray conduit (hidden) of the spray gun 30 and the reservoir 32. The reservoir 32 contains liquid (e.g., paint) to be sprayed, and is connected to the inlet port 48 either directly or by way of an optional adaptor 50. In use, the spray gun 30 is connected via a connector 52 at a lower end of the handle 42 to a source of compressed air (not shown). Compressed air is delivered through the gun 30 when the user pulls on the trigger 46 and paint is delivered under gravity from the reservoir 32 through the spray gun 30 to the nozzle 44. As a result, the paint (or other liquid) is atomized on leaving the nozzle 44 to form a spray with the compressed air leaving the nozzle 44.

As a point of reference, the present disclosure is not limited to a particular connection format or connection assembly 60 between the spray gun 30 and the reservoir 32. In general terms, the reservoir 32 includes one or more components establishing a first connection format for connection to the spray gun 30. A complementary, second connection format can be included with the adaptor 50 as assembled between the reservoir 32 and the inlet port 48, and/or with the inlet port 48 itself.

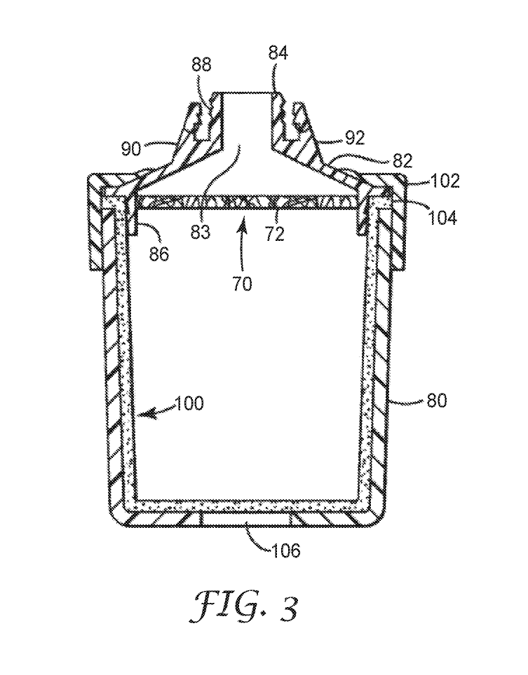

With the above background in mind, FIGS. 2 and 3 illustrate one non-limiting example of the reservoir 32 incorporating or carrying a filter 70 (or “knitted fabric filter”) having a knitted fabric filter media 72 (referenced generally) in accordance with principles of the present disclosure. In addition to the filter 70, the reservoir 32 includes an outer container 80 and a lid 82. The lid 82 has a central aperture 83 that leads to a spout or feed tube 84 providing a fluid outlet for the reservoir 32. The filter 70 is arranged to remove particulate material from the contained liquid (not shown) prior to delivery through the spout 84. The lid 82 can optionally include one or more additional features or structures, such as a skirt 86, and one or more connection features including external ribs or threads 88 along the spout 84 and hook members 90, 92 at opposite sides of the spout 84. Once again, a plethora of other connection formats are equally acceptable. Remaining components of the reservoir 32 can assume various forms and are optional. For example, in some embodiments the reservoir 32 further includes a liner 100 and a collar 102. In general terms, the liner 100 fits within the interior of the container 82 and can have a narrow rim 104 at the open end which sits on the top edge of the container 80. The lid 82 is configured to fit onto or in the open end of the liner 100 to locate the peripheral edge of the lid 82 over the rim 104 of the liner 100. The lid/liner assembly is secured in place by the annular collar 102 that releasably engages the container 80 (e.g., threaded interface as shown, snap fit, etc.).

As mentioned above, the lid 82 forms the spout 84 through which liquid contained by the liner 100 can flow. In use, the liner 100 collapses in an axial direction toward the lid 82 as paint is withdrawn from the reservoir 32. Air is permitted to enter the outer container 80 (in this embodiment through an optional vent hole 106 in the outer container 80) as the liner 100 collapses. On completion of spraying, the reservoir 32 can be detached from the spray gun 30 (FIG. 1), the collar 102 released and the lid/liner assembly removed from the outer container 80 in one piece. The outer container 80 and the collar 102 are left clean and ready for re-use with a fresh liner 100 and lid 82. In this way, excessive cleaning of the reservoir 32 can be avoided.

In other embodiments, the reservoirs of the present disclosure need not include the liner 100 and/or the collar 102. In some embodiments, the reservoir need not include the outer container (for example, the lid and liner may be separable or removable from the outer container such that the outer container is not needed during spraying). The knitted fabric filters and knitted fabric filter media of the present disclosure can be implemented with these and/or a plethora of other reservoir configurations that may or may not be directly implicated by the figures. For example, the knitted fabric filters and knitted fabric filter media of the present disclosure need not necessarily have the relatively planar format implicated by FIG. 3 and can instead be shaped in accordance with a particular reservoir design (e.g. cup-shaped, etc.) and/or may be pleated or corrugated, etc. In other embodiments, the knitted fabric filters of the present disclosure need not be integrally formed with the lid or other structural components of a corresponding reservoir assembly. In other embodiments, the knitted fabric filters of the present disclosure can alternatively be attached or preassembled to the end of a paint supply line or pouch, etc., and in turn connected to the spray gun paint inlet port. In this way, paint could be supplied directly to the spray gun without the need for other reservoir components. In yet other embodiments, the knitted fabric filters and knitted fabric filter media of the present disclosure can be employed to filter directly out of a paint dispensing mechanism. For example, knitted fabric filters and knitted fabric filter media of the present disclosure can be formed as cone-type filter; paint or other liquid can be pre-mixed and then poured through the cone-type filter into the dispensing cup/spray gun reservoir, thereby eliminating the need for an additional filter with the spray gun reservoir. Other paint filter and paint strainer embodiments can also be employed.

The knitted fabric filter media 72 includes or comprises a knit fabric or knitted fabric. One or more additional components can be included to support the knitted fabric filter media 72 as part of the filter 70. In contrast to a woven mesh or a woven fabric (that are otherwise excluded from the definition of “knitted fabric” as used throughout the present disclosure), with a knitted fabric, the filament(s) or thread(s) comprising the material follow a looped or meandering path (or “course”), forming symmetric loops (also called “blights”) above and below the mean path of the filament. “Course” is the horizontal row of loops across the width of the fabric produced by adjacent needles during the same knitting cycle. The number of courses determines the length of the fabric. The vertical column of loops in a knitted fabric is referred to as the “wale”. Wales are generally produced by the same needle knitting at successive knitting cycles. The number of wales determines the width of the fabric.

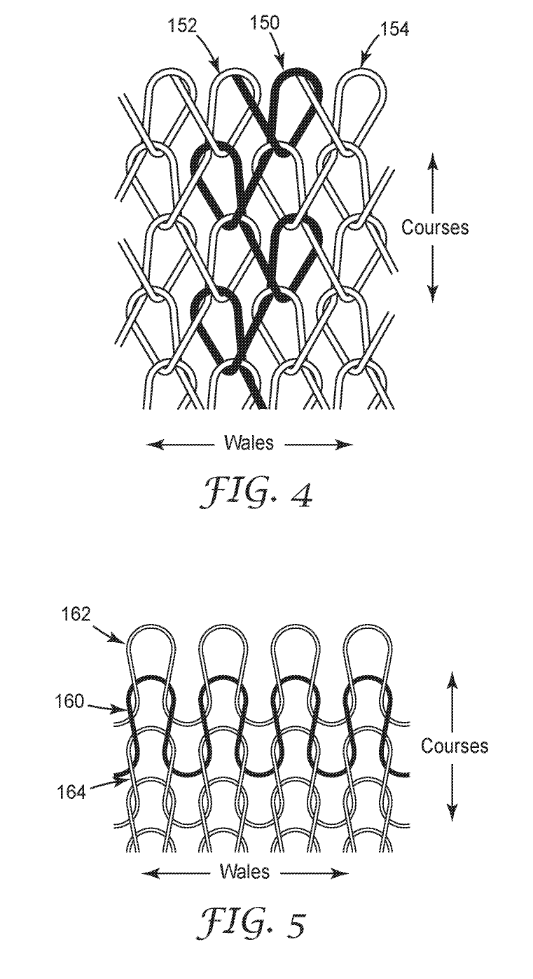

Knitted fabric can generally be classified by warp knitting or weft knitting. Warp knitting is a method of making fabric by normal knitting means in which the loop made from each warp filament or thread is formed substantially along the length of the fabric. In a warp knitting structure, each loop in the horizontal direction is made from a different fiber thread. FIG. 4 illustrates the stitch pattern of one basic warp knitted fabric in which a first filament or strand 150 follows a zig zag-like path, with each loop of the first filament 150 securing to a loop of an adjacent second filament 152 or third filament 154. In some embodiments, the knitted fabric filter media of the present disclosure incorporates a type of warp knitting that otherwise minimizes possible unraveling during cutting/converting processes.

Alternatively or in addition, the knitted fabric filter media of the present disclosure can incorporate weft knitting. Weft knitting is a method of making a fabric by normal knitting means in which the loop made from each weft thread or filament is formed substantially along the length of the fabric, characterized by the fact that each warp thread is fed more or less in line with the direction in which the fabric is produced. For example, FIG. 5 illustrates the stitch pattern of one basic weft knitted fabric in which loops of a first filament or strand 160 have been pulled through the loops of a second filament or strand 162; further, loops of a third filament or strand 164 have been pulled through the loops of the first filament 160.

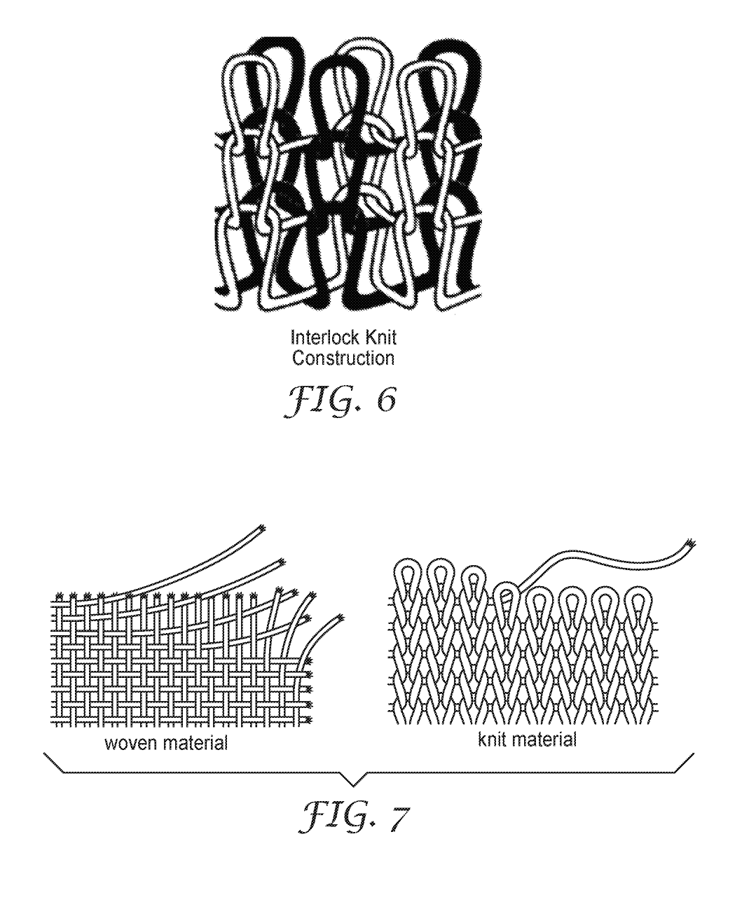

Using industrial knitting machinery (e.g., weft knitting machines such as flat bar knitting machines, straight bar knitting machines, circular knitting machines, circular bearded single knitting machine; warp knitting machines such as rachel knitting machines and tricot knitting machines), a plethora of different knitted fabric configurations can be achieved and are useful as the filters of the present disclosure. For example, an interlock knit (FIG. 6) can be generated by long and short needles arranged alternately in both dial and cylinder components of the circular knitting machine; the needles in the dial and cylinder are also positioned in direct alignment. When the long and short needles knit in alternate feeds in both needle housings, a knitted fabric with a type of cross 1×1 rib effect is produced. One or more other common knitted fabric stitch patterns or styles may be useful with the knitted fabric filters of the present disclosure, including (but not limited to) weft plain stitch, rib stitch, purl stitch, chain stitch, pillar stitch, tricot stitch, satin tricot stitch, double loop stitch, derivative stitch, interlock stitch, cord stitch, tuck stitch, half cardigan stitch, full cardigan stitch, blister stitch, plating stitch, weft laid—in stitch, laying—in stitch, jacquared stitch, terry stitch, pile stitch, lace stitch, racked stitch, locknit stitch, reverse locknit, atlas stitch, queen's cord, miss-lapping stitch, miss-pressing stitch, and fall-plate stitch.

Regardless of exact form, the inventors of the present disclosure have surmised and surprisingly discovered that knitted fabric can be used as the spray gun reservoir filter media 72 (FIG. 3), in place of conventional woven mesh filters. As a point of reference, while knitted fabrics have been considered as media separation for tangential flow (i.e., to maintain spacing between adjacent layers of media, which spacing would otherwise collapse under differential pressure, as well as turbulence and z-axis mixing of the material), knitted fabric is not commonly understood or viewed as being a viable small particle filtration media, especially in the context of filtering small particles from painting products as part of a spray gun reservoir. The differences between a woven material and a knitted material are generally reflected by FIG. 7. Perhaps due to the substantially uniform shape, size and distribution of the openings or pores that is readily provided by woven mesh, woven mesh filters have been viewed as the only viable option for some time. Moreover, because knitted fabrics are typically characterized by complexly-shaped openings or “pores,” knitted fabric manufacturers do not normally consider or specify pore size as a meaningful attribute of the knitted fabric; absent this information or other recognition by knitted fabric manufacturers as to the importance of pore size, those in the paint spray gun industries have not previously considered knitted fabric as a possible spray gun reservoir filter material. However, the inventors of the present disclosure have surprisingly discovered and surmised that not only can the knitted fabric filters of the present disclosure achieve porosity characteristics (e.g., pore size) in accord with those of woven mesh filters conventionally used with spray gun reservoirs in the automotive painting industry, but opportunities for improvements or advantages over woven mesh filters exist.

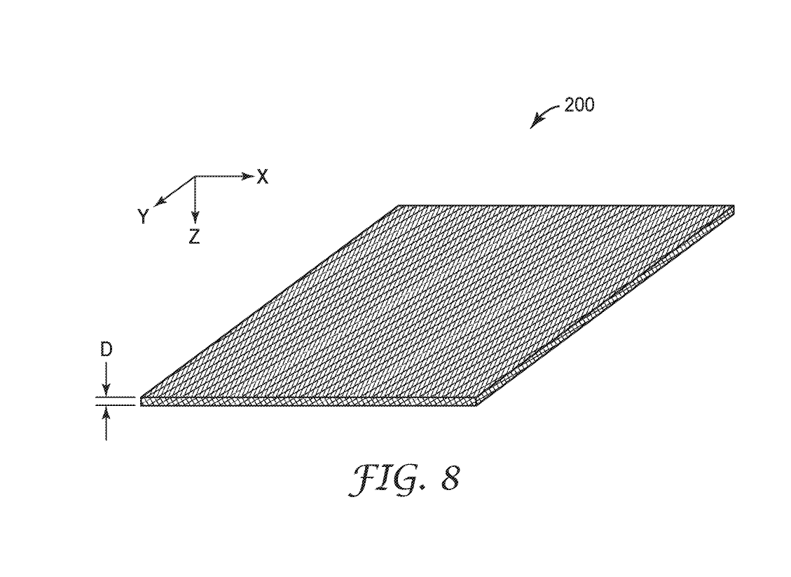

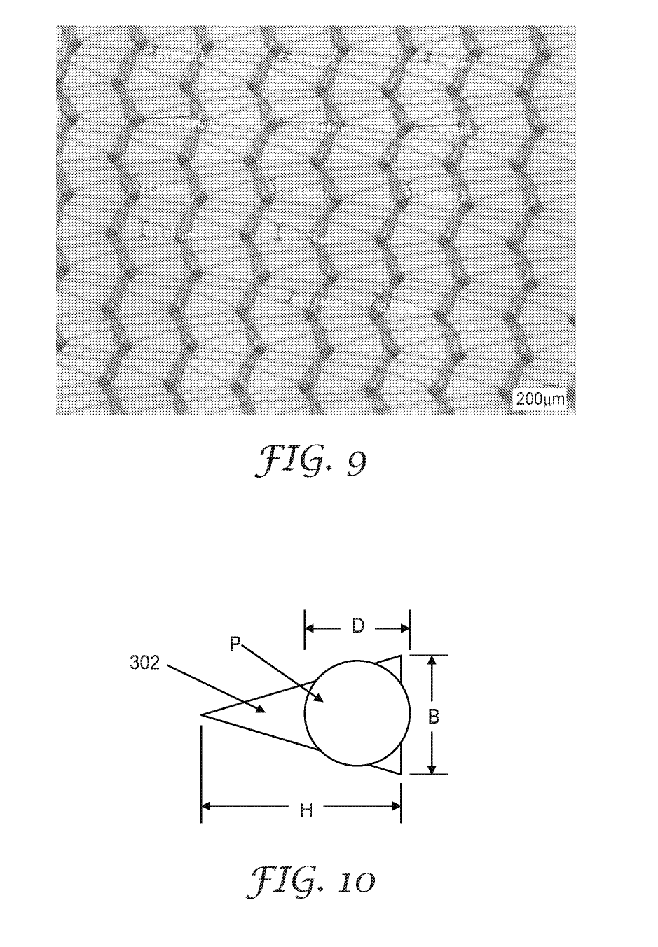

For example, due to the multiplicity of different knitting types, patterns or formats available with knitted fabrics, a plethora of different opening or pore geometries can be provided in one or both of the X, Y plane (i.e., plane parallel to the opposing major faces of the knitted fabric) and the Z or depth direction. By way of clarification, FIG. 8 is a simplified representation of a knitted fabric filter media 200, and identifies the X, Y, and Z directions; the knitted fabric filter media defines a depth (or thickness) dimension D along the Z axis. Returning to FIG. 7, in contrast to some of the knitted fabric filter media of the present disclosure, the pore geometry of woven mesh filters is effectively limited to a parallelogram (e.g., square or rectangular) shape in the X, Y plane that is uniform or constant in the depth direction. With respect to a shape of the pore(s) in the X, Y plane, some or all of the pores provided by the knitted fabric filters of the present disclosure can have a geometry other than parallelogram, including regular or uniform shapes (e.g., triangle, pentagon, etc.) and irregular or complex shapes. With some relatively simple knitted fabric formats (e.g., represented by FIG. 7 that otherwise illustrates the X, Y plane), the shape or geometry of the pores or openings in the X, Y plane is relatively uniform or consistent throughout the knitted fabric (e.g., with the non-limiting example knitted fabric of FIG. 7, the pores all have a geometry approximating a pentagon). With many other configurations, two or more differently-shaped pores are provided across the knitted fabric filter. For example, a micrograph of a knitted fabric material 300 useful as or with the reservoir filters of the present disclosure is provided in FIG. 9 (it being understood that a major face of the knitted fabric material 300 is visible in FIG. 9, such that the descriptions below with respect to pore shapes are relative to the X, Y plane). The knitting technique utilized with the knitted fabric material 300 generates a repeating pattern of several differently-shaped pores or openings, such as first pores 302, second pores 304, third pores 306, and fourth pores 308. An ability of the knitted fabric material 300 to filter or remove particles of interest from liquid is a function of the larger size pores; thus, because a size of the fourth pores 308 is significantly less than that of the first-third pores 302-306, the fourth pores 308 have minimal relevance. The first pores 302 have a substantially triangular shape or geometry, and an open area greater than that of the second and third pores 304, 306. The second pores 304 have a trapezoid shape or geometry, and an open area greater than that of the third pores 306. The third pores 306 have a rectangular shape or geometry. In other embodiments, other pore geometries or shapes can be provided. By formatting two or more differently shaped pores into the knitted fabric filters of the present disclosure, filtration effects otherwise not available with conventional woven mesh filters are achieved.

The non-limiting example of FIG. 9 further reflects that the knitted fabric filter media of the present disclosure can provide a controlled or non-random distribution of differently sized or shaped pores across the filter. In contrast, conventional woven mesh filters are inherently limited to a uniform distribution of identically sized or shaped pores. The controlled distribution of differently sized or shaped pores optionally embodied by knitted fabric filter media of the present disclosure can enhance overall filter performance, such as by removing particles of interest with lesser overall effect on liquid flow rate (as compared to conventional woven mesh filters). Moreover, the pore size or shape can by dynamically adjusted across or along the knitted fabric filter media via the selected knitting process, again leading to possible performance improvements over conventional woven mesh filters.

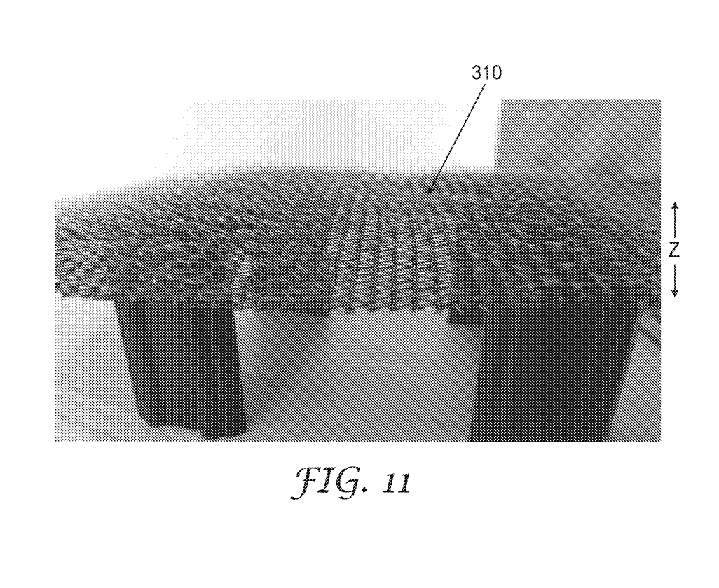

It is recognized that filtration efficacy of a particular knitted fabric filter media is primarily a function of the largest sized pores provided by the knitted fabric filter (i.e., if the filter is intended to remove particles of a specified minimum diameter or larger, then the largest sized pores associated with that filter should be no greater than the specified minimum diameter). Thus, with the non-limiting example of FIG. 9, the first pores 302 are of interest with respect to filter viability, presenting an open area greater than that of the second-fourth pores 304-308. Due to the triangular shape of the first pores 302, however, it is surmised that less than an entirety of the open area of the first pores 302 is relevant to the determination of filtration efficacy, and in particular the particle size that will pass or not pass through the first pores 302. The shape of the first pores 302 can be viewed as defining a height dimension H greater than a base dimension B. As schematically reflected in FIG. 10, a particle P having a diameter D slightly less than the height dimension H will not pass through the first pore 302 due to the tapered, triangular shape. Instead, the effective porosity (for purposes of particle filtration) provided by the first pores 302 is on the order of one-half the height H multiplied by the base B. Thus, the triangular shaped pores associated with some knitted fabric filter media of the present disclosure can have dimensions larger than a specified minimum particle diameter (and are thus more easily manufactured). Similar analyses apply to other pore shapes of the knitted fabric filter media of the present disclosure, such as the second and third pores 304, 306 of FIG. 9.

In addition or as an alternative to shaping of the pore(s) in the X, Y plane, knitted fabric filter media of the present disclosure can incorporate geometry features in the Z or depth dimension differing from the relatively uniform Z depth dimension geometry provided by conventional woven mesh filters. The selected knitting process can produce knitted fabric filter media with thickness or depth dimensions greater than conventional woven mesh filter media; depth dimensions or geometries that vary (e.g., in a controlled or non-random distribution or manner) across the knitted fabric filter media; tortuous pore or aperture paths in the depth dimension that may assist with the capture of more complex particle shapes (as compared to a simply two dimensional aperture or pore as found with conventional woven mesh filters), etc. By way of non-limiting example, FIG. 11 is a photograph of a knitted fabric filter media 310 in accordance with principles of the present disclosure; the view of FIG. 11 is primarily from a side of the knitted fabric filter media 310 and thus is indicative of the Z axis (along which the depth dimension D (FIG. 8) is defined). As implicated by FIG. 11, features of the knitted fabric filter media 310 project in the Z dimension, creating tortuous pores or aperture paths in the Z or depth dimension that vary across the knitted fabric filter media 310.

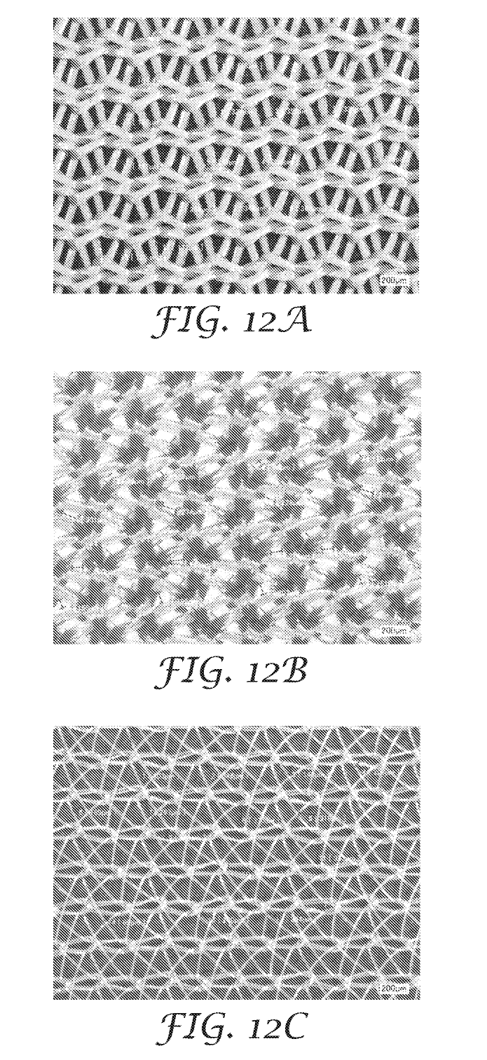

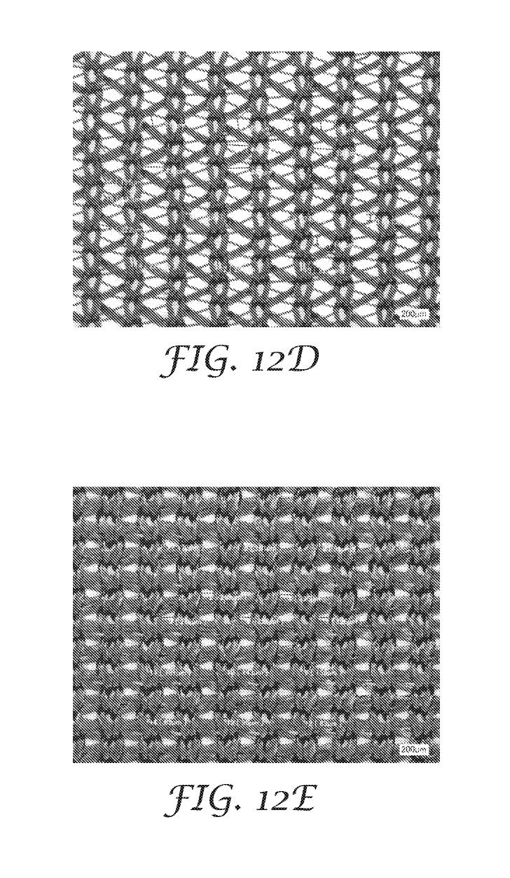

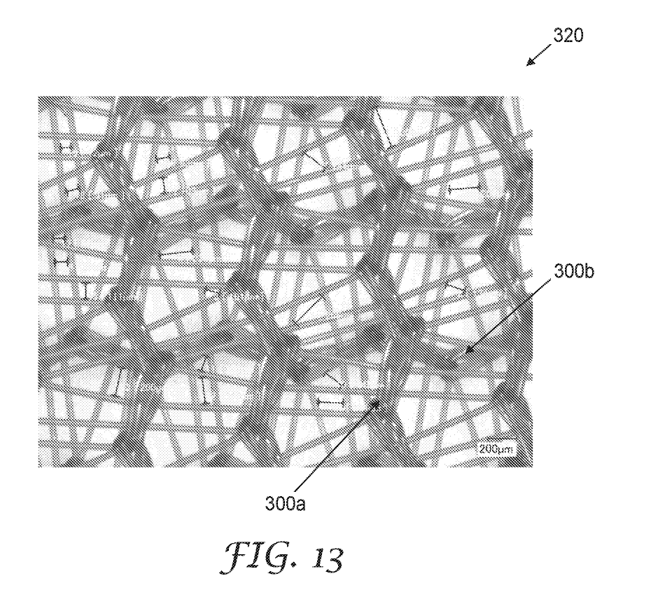

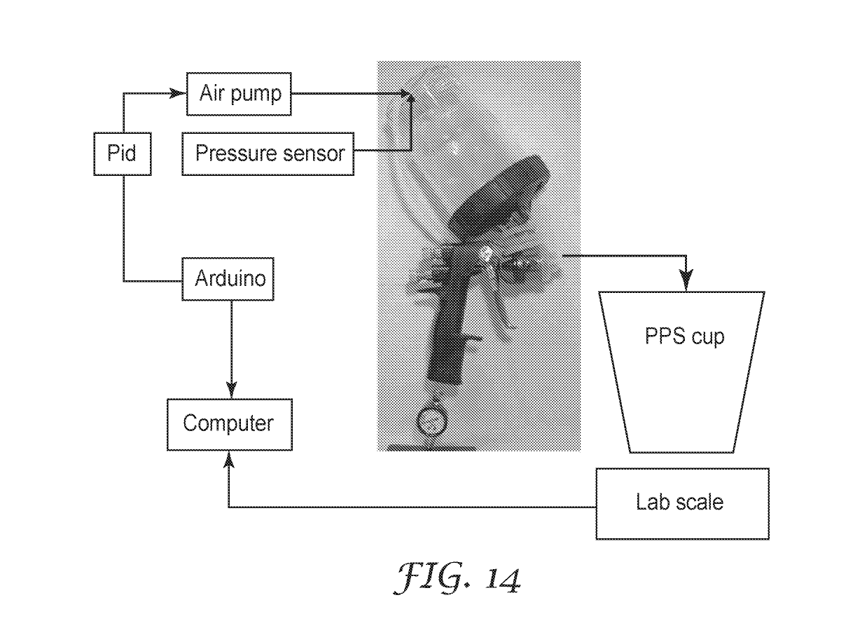

The format or pattern embodied by the knitted fabric filter media of the present disclosure can assume a wide variety of other forms. Non-limiting examples of other knitted arrangements in accordance with principles of the present disclosure are provided in FIGS. 12A-12E.

In other embodiments, the knitted fabric filter media of the present disclosure include two (or more) knitted fabric layers. With these optional constructions, the two or more layers generate a depth filtration media. Further, with embodiments in which the knitted fabric layers comprising the filter media have non-uniform pores and/or pores of a larger-than-desired size, the knitted fabric layers can be strategically arranged relative to one another to reduce the effective size of any larger pores within any one particular layer. For example, FIG. 13 is a micrograph of another, non-limiting embodiment filter media 320 in accordance with principles of the present disclosure, and comprises two layers 300a, 300b of the knitted fabric material 300 described above with respect to FIG. 9. The layers 300a, 300b are arranged orthogonally relative to one another, with the result that fibers or threads in one layer “cross over” various pores in the other layer, thereby reducing the effective open area or size of any one particular opening. Other multiple layer knitted fabric filter media configuration are envisioned, with the layers having the same or different construction. For example, the multiple layers can each provide course/fine holes; larger holes would protect the finer media from plugging, preserving their functionality and making the resultant filter more effective. In related embodiment, the knitted fabric comprising the knitted fabric filter media can be generated by a circular knitting (or similar) process, resulting in a cylindrical or tubular construction; the cylindrical construction differentiates from the flat or planar nature of conventional woven mesh filters, potentially providing more surface area and less surface tension concerns. In yet other embodiments, the knitted fabric filter media can be manipulated geometrically, such as with pleating, corrugation, etc., forming into a conical shape, and the like.

The knitted fabric filter media of the present disclosure can employ a wide variety of different types of base filaments or fibers. In some embodiments, a nylon filament is used to form the knitted fabric filter media, akin to nylon filaments used with conventional woven mesh filter media. Alternative filament constructions are readily incorporated into the knitted fabric filters of the present disclosure such that filament types other than, or in addition to, nylon filaments are readily available and can be selected based upon, for example, desired filtering effects, manufacturing speed, costs, etc. For example, a multi-filament construction can be incorporated into the knitted fabric filter media of the present disclosure utilizing conventional knitting machinery with minimal effect on mass production costs. Moreover, filaments that have been pigmented or dyed to a desired, distinct color can be incorporated into the knitted fabric filter media of the present disclosure using existing industrial knitting machines. With these and related embodiments, reservoir lids in accordance with principles of the present disclosure can include a colored knitted fabric filter, with the selected color of the knitted fabric filter being indicative of a feature of the knitted fabric filter and/or of the resultant reservoir assembly, such as filter porosity akin to color schemes conventionally incorporated into existing reservoir lids (e.g., a first color designates 125 micron porosity rating, and a second color designates a 200 micron porosity rating). Unlike existing reservoir lids, however, coloring of the lid or a filter holder itself is not required (as instead, the colored knitted fabric filter carried by the lid visually indicate a porosity rating), thus presenting a cost savings.

As a point of reference, conventional woven mesh filters cannot readily incorporate the differing filament(s) constructions of the knitted fabric filter media of the present disclosure, especially on a mass production basis. Due to the ease with which most industrial knitting machines can receive, handle and process different filament types during a single, continuous production run in forming a knitted fabric (as compared to industrial weaving machines), filaments utilized in forming a particular knitted fabric filter media can quickly easily be changed during continuous operation. In contrast, mass production operation of industrial weaving machinery in the manufacture of conventional woven mesh filter media requires batch processing to be economically viable. With batch processing, an extremely long length of a single filament type is supplied to the weaving machinery and is the basis for the production run size. A minimum order quantity is required due to the significant setup time on the weaving machine (pre-winding, re-winding, threading, etc.). Weaving machinery operators are unwilling to stop and restart the weaving machine during a production run in order to introduce a different filament type. Instead, weaving machinery operators strongly prefer to utilize a relative generic or widely-viable filament to generate a large volume of woven mesh filter media that meets industry specifications, and then slit the large volume into smaller quantities for sale to multiple different customers. In addition, knitting may be less expensive than weaving such that some of the knitted fabric filter media of the present disclosure may be less expensive than conventional woven mesh filter media.

As a further benefit, many industrial weaving machines inherently and undesirably introduce siloxane or other silicone material into the woven mesh during production. It is surmised that conventional industrial knitting machines do not give rise to a similar concern, such that the knitted fabric filters of the present disclosure may be consistently produced as a silicone free material in some embodiments.

### EXAMPLES

Objects and advantages of the present disclosure are further illustrated by the following non-limiting examples and comparative examples. The particular materials and amounts thereof recited in these examples, as well as other conditions and details, should not be construed to unduly limit the present disclosure.

Example knitted fabric filters in accordance with principles of the present disclosure were generated from knitted material samples. Example A was a knitted fabric filter media generated from a knitted fabric material obtained from Apex Mills of Inwood, N.Y. (“Apex”) available under the trade designation “N98”. Example B was a knitted fabric filter media generated from a knitted fabric obtained from Apex under the trade designation “NB20”. Example C was a knitted fabric filter media generated from a knitted fabric obtained from Apex under the trade designation “NF75”. Example D was a knitted fabric filter media generated from a knitted fabric obtained from Apex under the trade designation “NK04”. Example E was a knitted fabric filter media generated from a knitted fabric obtained from Apex under the trade designation “NX91”. Example F was a knitted fabric filter media generated from a knitted fabric obtained from Apex under the trade designation “NZ11”. Example G was a knitted fabric filter media generated from a knitted fabric obtained from Sitip S.p.A. Industrie Tessili of Cene (BG), Italy (“Sitip”) available under the trade designation “Cam B 45/50”. Example H was a knitted fabric filter media generated from a knitted fabric obtained from Sitip under the trade designation “Cam SPB 90/95”. Example I was a knitted fabric filter media generated from a knitted fabric obtained from Sitip under the trade designation “Tel 28/3”.

The sample filters of Examples A-I were each assembled to, and used as the filter of, a spray gun reservoir assembly available from 3M Company, St. Paul, Minn. under the trade designation 3M™ PPS™ Type H/O Pressure Cup (including a liner and outer container).

To evaluate the effect the knitted fabric filters of Examples A-I on flow rate, flow testing was simulated using a spray gun testing system depicted in FIG. 14 that included a spray gun available from 3M Company of St. Paul, Minn. under the trade designation 3M Accuspray Spray Gun Model HG14 1.4 mm (part number 16577). A jet black paint available from PPG Industries, Inc. of Pittsburgh, Pa. under the trade designation PPG Envirobase T407 was used as the sample paint for flow rate evaluations. Each sample reservoir assembly as described above was outfitted with a pressure sensor and an air pump that in turn were connected to an Arduino programmable microcontroller. The microcontroller was programmed to control pressure at the reservoir assembly via the air pump, maintaining a constant pressure inside the sealed cup (the Arduino microcontroller reads pressure from the pressure sensor and adjusts the air pump accordingly). A pressure set point of 6 kPa was used as the pressure set point for the testing. As a point of reference, it is known that high velocity atomization air creates a net vacuum on the spray gun system, which augments gravity-based flow forces and aids in achieving desirable flow rates during spraying. It is also known that typical mass flow rates during air impingement spray with typical automotive paints range from 3-5 g/sec. By pressurizing the cavity between the sealed container and flexible liner of the reservoir assembly, the vacuum forces created during atomization can be mimicked, avoiding the need to atomize a liquid spray while measuring fluid mass flow. Through trial and error, 6 kPa was determined as producing a flow rate of 3 g/sec in a repeatable manner utilizing a 125 micron woven mesh filter, standard size PPS™ lid and was thus selected as an appropriate pressure set point for testing purposes. With each flow rate test, the spray gun and reservoir cup assembly as in FIG. 14 were held in a rigid fixture, and the spray gun's trigger secured in the fully pulled position, allowing a stream of the sample paint to be expelled from the sample reservoir assembly, into and through the spray gun, and from the nozzle outlet orifice of the gun into a reservoir on a digital laboratory scale. The mass and elapsed time were recorded via a serial protocol at a sampling rate of approximately 100 Hz. At the completion of the test period, the mean steady state slope of mass per time was extracted in order to determine the mass flow rate.

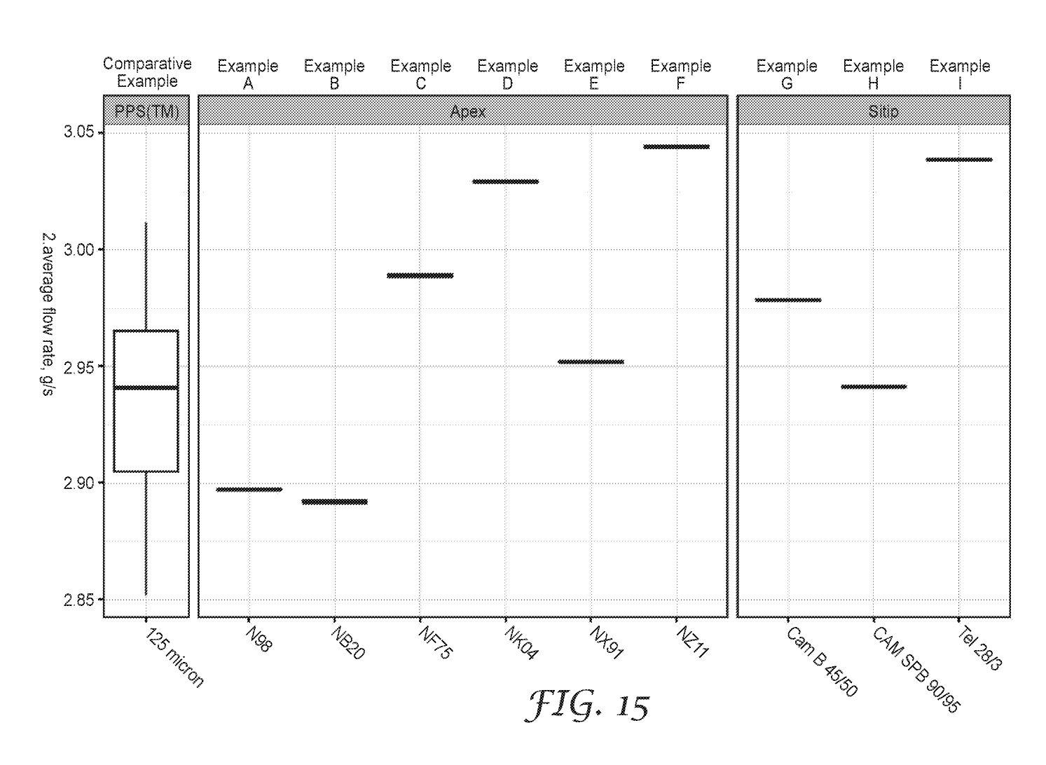

Results of the flow rate testing are provided in FIG. 15. The flow rate of a Comparative Example reservoir assembly (or “PPS”) commercially available under the trade designation 3M™ PPS™ Type H/O Pressure Cup and containing a 125 micron woven mesh filter was also tested, with results reported in FIG. 15. As shown, the knitted fabric filters of the Examples generated flow ranges predominantly overlapping those obtained for the Comparative Example, indicating that although the knitted fabric filters of Examples A-I may have decreased open area (as compared to the Comparative Example), the knitted fabric filters of the present disclosure should not pose an issue for paint flow.

Thickness (Z or depth dimension) measurements were obtained for the knitted fabric filter media of Examples A-I using a Mitutoyo 500-196-30 Advanced Onsite Sensor (AOS) digital caliper. In each instance, thickness was measured at least three times, and if there was a difference between individual measurements, minimum and maximum values were recorded. The results are reported in the Table below. Thickness measurements were similarly obtained for the knitted fabric filter media of FIG. 11 (“Example J”). In this regard, and as evidenced by the photograph of FIG. 11, the knitted fabric filter media of Example J is “lofty” with loop-like structures projecting in the Z dimension; thickness measurements were obtained under first testing conditions in which the digital caliper barely touched the opposing faces of the media (such that loop-like structures were minimally compressed, if at all), and under second testing conditions in which the digital caliper was firmly compressed on to the media. The results are reported in the Table below, including thickness measurements under the first testing condition (“Test 1”) and under the second testing condition (“Test 2”). For purposes of comparison, thickness measurements where similarly obtained for 125 micron woven mesh filter (“CE1”) obtained from a PPS™ Type H/O Pressure Cup and a 200 micron woven mesh filter (“CE2”) obtained from a PPS™ Type H/O Pressure Cup, both available from 3M Company, St. Paul, Minn. The results are reported in the Table below.

TABLE

| | Thickness |
|---|---|
| Sample | (mm) |
| Example A | 0.32-0.33 |
| Example B | 0.47-0.49 |
| Example C | 0.15-0.17 |
| Example D | 0.18-0.20 |
| Example E | 0.21 |
| Example F | 0.21-0.22 |
| Example G | 0.21 |
| Example H | 0.28 |
| Example I | 0.25 |
| Example J | 2.6-2.8 |
| (Test 1) | |
| Example J | 0.62-0.67 |
| (Test 2) | |
| CE1 | 0.10 |
| CE2 | 0.18-0.19 |

Although the present disclosure has been described with reference to preferred embodiments, workers skilled in the art will recognize that changes can be made in form and detail without departing from the spirit and scope of the present disclosure.

1. A spray gun reservoir comprising:
a cup defining a containment volume;
a lid defining an outlet; and
a filter disposed between the containment volume and the lid such that liquid flowing from the containment volume to the outlet interfaces with the filter;
wherein the filter includes a knitted fabric filter media.

2. The spray gun reservoir of claim 1, wherein the knitted fabric filter media includes filaments knitted in a pattern including at least one of weft knitting and warp knitting.

3. The spray gun reservoir of claim 1, wherein the knitted fabric filter media includes filaments knitted to one another to define a plurality of pores, and further wherein at least some of the plurality of pores have a non-square shape.

4. The spray gun reservoir of claim 3, wherein the non-square shape is a triangular shape.

5. The spray gun reservoir of claim 4, wherein a size of the triangular shaped pores defines a largest pore size of the knitted fabric filter media.

6. The spray gun reservoir of claim 1, wherein the knitted fabric filter media includes filaments knitted to one another to define a plurality of pores including first pores and second pores, wherein a size of each of the first pores is greater than a size of each of the second pores, and further wherein the first and second pores are distributed across the knitted fabric filter media in a controlled, non-random manner.

7. The spray gun reservoir of claim 1, wherein the knitted fabric filter media includes a first knitted fabric layer disposed over a second knitted fabric layer.

8. The spray gun reservoir of claim 7, wherein a distribution of pores in the first knitted fabric layer differs from a distribution of pores in the second knitted fabric layer.

9. The spray gun reservoir of claim 7, wherein the first and second knitted fabric layers combine to define a depth filter.

10. The spray gun reservoir of claim 1, wherein the knitted fabric filter media includes filaments knitted to one another to define a plurality of pores, and further wherein at least one of the plurality of pores defines a tortuous path in a depth dimension of the knitted fabric filter media.

11. The spray gun reservoir of claim 1, wherein the knitted fabric filter media includes filaments knitted to one another to define a plurality of pores, and further wherein each of the filaments exhibits a color corresponding to a feature of the reservoir.

12. The spray gun reservoir of claim 11, wherein the feature is a porosity of the knitted fabric filter media.

13. The spray gun reservoir of claim 1, wherein the filter is relatively flat.

14. The spray gun reservoir of claim 1, wherein the filter is conical.

15. The spray gun reservoir of claim 1, wherein the filter is cylindrical.
